(19) United States
(12) Patent Application Publication
(10) Pub. No.: US 2017/0098485 A1
(43) Pub. Date: Apr. 6, 2017

(54) Reduction of Radioactivity Emitted from Radioactive Material

(71) Applicant: Leif A. Poulsen, Langley (CA)

(72) Inventor: Leif A. Poulsen, Langley (CA)

(21) Appl. No.: 14/876,717

(22) Filed: Oct. 6, 2015

(51) Int. Cl. G21F 1/06; G21F 9/36; G21F 3/00; G21F 9/30

(52) U.S. Cl. CPC G21F 1/06; G21F 9/30; G21F 9/36; G21F 3/00; G21Y 2002/501; G21Y 2002/60; G21Y 2004/10; G21Y 2004/305

(57) ABSTRACT

A method of reducing radiation emitted from a radioactive source material involves mixing the radioactive material with mica. Uranium ore is a radioactive source material which when mixed with mica significantly reduces the amount of radiation emitted. The radioactive source material and the mica may be ground to similar sized small pieces and mixed at a one to one ratio. The radioactive source material and the mica may be consistently mixed together. In the alternative the mica may be placed around the outside of the radioactive source material. The mica may contain manganese.

### TECHNICAL FIELD

The present invention relates to the effective reduction of radioactivity from radioactive material, specifically uranium and its related decay chain radioactive elements.

### CROSS REFERENCE TO RELATED APPLICATIONS

None.

### GOVERNMENT SUPPORT

None.

### BACKGROUND

Exposure to significant amounts of radiation is harmful to the human body and can cause a variety of ailments, cancers, and even death depending upon the amount of radioactivity absorbed.

Nuclear power plants generate electricity by harnessing heat produced by nuclear fission to turn water into steam that drives turbines. Nuclear power plants are much less of a concern for greenhouse gas emissions and global warming as compared to fossil fuel power plants that burn coal, oil or gas and generate large qualitites of carbon dioxide. However spent nuclear fuel from nuclear power plants remains radioactive and extremely dangerous for several thousand years.

Accidents involving nuclear power plants, such as occurred in Fukushima, Japan on Mar. 11, 2011 and in Chernobyl, Ukraine (USSR) on Apr. 26, 1986 cause significant spread of radioactive material and radiation.

Uranium-238 is the most common isotope of uranium found in nature, about 99% of natural uranium, and has a half-life of 4.468 billion years.

Uranium-236 is an isotope of uranium that is found in spent nuclear fuel and in the reprocessed uranium made from spent nuclear fuel. It has a half-life of 23.48 million years.

There is a need for a way to safely reduce the radioactivity of radioactive material, including reducing the radiation emitted from spent nuclear power plant fuel and from radioactive material emitted in a nuclear power plant accident.

There is a need for a way to safely reduce radiation for people, the environment, soil, water and the atmosphere.

### SUMMARY OF INVENTION

A method of reducing radiation emitted from a radioactive source material involves mixing mica with the radioactive source material.

The radioactive source material is ground to small granules, to dust size particles, and/or to 200 mesh.

The radioactive source material and the mica can be mixed in a ratio of one to one. The mica used can be dark mica and the mica can contain at least 800 ppm of manganese. In some embodiments the mica can contain at least 1300 ppm of manganese. The mica can also contain at least 700 ppm of phosphorus, at least 1 percent potassium, at least 3 percent iron, and/or at least 3 percent aluminum.

The radioactive source material can comprise uranium.

The mica can be arranged to surround the radioactive source material.

### BRIEF DESCRIPTION OF DRAWINGS

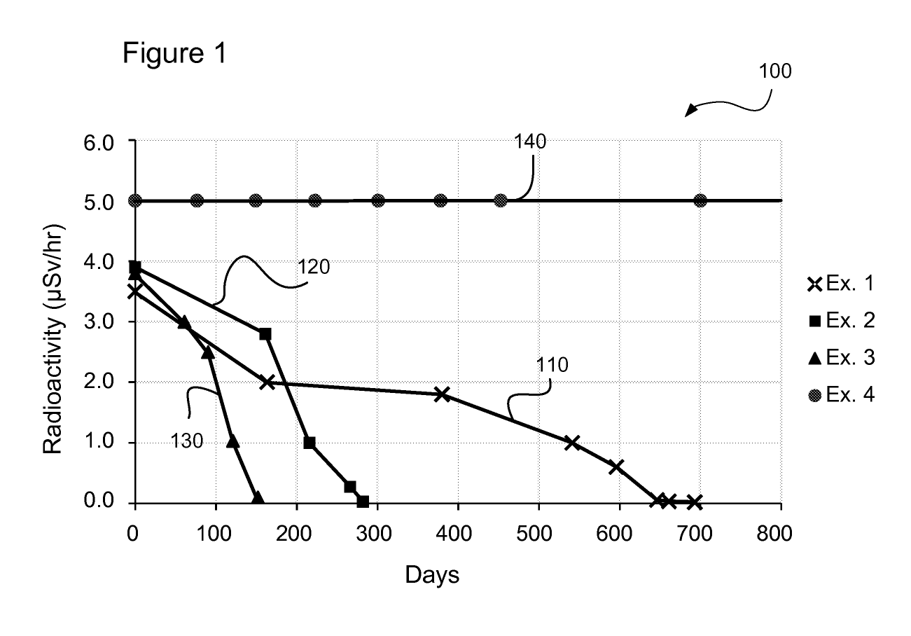

In a FIGURE which illustrates aspects of non-limiting embodiments of the invention, FIG. 1 is a graph showing radioactivity readings plotted against time for Examples 1-4.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

It occurred to the inventor that mica could be used as a way to reduce the radioactivity in a given sample of uranium. The inventor surmised that if it is shown to work for a test sample then it would also have much broader application.

Mica is a type of crystal that occurs naturally in igneous, metamorphic and sedimentary rock. Mica is used to describe sheet silicate (phyllosilicate) minerals which have the general chemical formula:

X₂Y₄₋₆Z₈O₂O(OH,F)₄

in which

X is K, Na, or Ca or sometimes Ba, Rb, or Cs;

Y is Al, Mg, or Fe or sometimes Mn, Cr, Ti, Li, etc.;

Z is usually Si or Al, but also may include Fe3+ or Ti.

Muscovite is a phyllosilicate mineral of aluminum and potassium with formula:

KAl₂(AlSi₃O₁₀)(F,OH)₂ or (KF)₂(Al₂O₃)₃(SiO2)₆(H₂O).

For the purposes of testing, a reference grade radioactive sample of Pitchblende BL-5/U-238 (hereinafter BL-5) was purchased from Energy Mines and Resources in Ottawa, Ontario, Canada. Experimental tests with BL-5 and mica were conducted to confirm the invention.

BL-5 is a low-grade concentrate from Beaverlodge, Saskatchewan, Canada. BL-5 is in secular equilibrium.

TABLE 1
Certificate of Analysis for BL-5

| Consensus Value | | 95% Confidence Interval |
|---|---|---|
| U | 7.09% | ±0.03% |
| Ra-226 | 857 Bq/g | ±38 Bq/g |
| Pb-210 | 866 Bq/g | ±21 Bq/g |

The preparation and certification procedures used for BL-5 are set out in CANMET Reports 79-4 “Uranium Ore BL-5—a Certified Reference Ore” which is available from CCRMP, CANMET in Ottawa, Ontario, Canada.

The present invention will be further clarified by the following specific examples, which are intended to be purely exemplary of the present invention, and the scope of the invention is not limited to the examples.

### Example 1: 9.9 g of BL-5 with 9.9 g of Mica #1

In a laboratory, 9.9 g of BL-5 was mixed with 9.9 g of a first type of mica (“mica #1”), which is a muscovitic-type mica schist, and the radiation emitted from the combined sample was measured, using a Geiger Counter, over time.

TABLE 2
Measured Radioactivity of Example 1

| Days | Radioactivity (μSv/hr) |
|---|---|
| 0 | 3.500 |
| 163 | 2.000 |
| 380 | 1.800 |
| 541 | 1.000 |
| 596 | 0.600 |
| 646 | 0.058 |
| 661 | 0.032 |
| 693 | 0.020 |

### Example 2: 10.1 g of BL-5 with 10.1 g of Mica #2

In a laboratory, 10.1 g of BL-5 was mixed with 10.1 g of a second type of mica (“mica #2”), which is a dark mica, and the radiation emitted from the combined sample was measured, using a Geiger Counter, over time.

TABLE 3
Measured Radioactivity of Example 2

| Days | Radioactivity (μSv/hr) |
|---|---|
| 0 | 3.900 |
| 161 | 2.800 |
| 216 | 1.000 |
| 266 | 0.271 |
| 282 | 0.035 |

### Example 3: 70.0 g of BL-5 with 70.0 g of Mica #2

In a laboratory, 70.0 g of BL-5 was mixed with 70.0 g of the second type of mica and the radiation emitted from the combined sample was measured over time.

TABLE 4
Measured Radioactivity of Example 3

| Days | Radioactivity (μSv/hr) |
|---|---|
| 0 | 3.800 |
| 61 | 3.000 |
| 90 | 2.500 |
| 121 | 1.030 |
| 152 | 0.100 |
| 215 | 0.200 |
| 246 | 0.075 |

For examples 1-3, the BL-5 and the mica were combined at approximately the same size particles, with the mica ground to 200 mesh.

### Example 4: 50.0 g of BL-5 without Mica

BL-5 is a reference material which contains radioactive material, primarily uranium, which is not expected to appreciably decrease in radioactivity for thousands of years. A control experiment was not yet performed however it is expected that the radioactivity of a control sample of BL-5 would not change measurably over a period of years.

TABLE 5
Expected Radioactivity of Example 4

| Days | Radioactivity (μSv/hr) |
|---|---|
| 0 | 5.0 |
| 75 | 5.0 |
| 150 | 5.0 |
| 225 | 5.0 |
| 300 | 5.0 |
| 375 | 5.0 |
| 450 | 5.0 |
| 700 | 5.0 |

The base reading of radioactivity for the BL-5 immediately prior to mixing with mica in examples 1-3 was measured as 5.0 μSv/hr.

FIG. 1 is a graph 100 plotting Radioactivity (μSv/hr) over Time (Days) for the above example 1 as plotted with line 110, example 2 which is plotted as line 120, example 3 plotted as line 130 and example 4 plotted as line 140. As can be seen for examples 1-3, the initial mixing of mica with the BL-5 resulted in an immediate drop (from 5 μSv/hr) for measured radiation emitted, and then the radiation emitted continued to drop off over time until it reached background radiation levels. In examples 2 and 3 wherein mica #2 was used, the completed drop off in radiation emitted took less than one year, whereas for example 1 using mica #1 it took less than two years.

The mica #1 was chemically analyzed for constituents and was found to have the following elements in decreasing order measured by percentage.

TABLE 6
Analysis of Mica #1

| Element | Percentage |
|---|---|
| Mg | 5.12% |
| Al | 3.93% |
| Fe | 3.88% |
| K | 2.82% |
| Ca | 0.57% |
| P | 0.37% |
| Na | 0.11% |
| Ti | 0.10% |
| S | <0.01% |

The mica #1 was chemically analyzed for additional constituents and was found to have the following elements in decreasing order measured in parts per million (ppm).

TABLE 7
Analysis of Mica #1

| Element | PPM |
|---|---|
| Cr | 895 |
| Mn | 871 |
| Ni | 336 |
| Zn | 316 |
| Be | 229 |
| Ba | 82 |
| Co | 38 |
| V | 38 |
| Ga | 29 |
| Pb | 22 |
| Sr | 19 |
| Sb | 14 |
| B | 10 |

The mica #2 was chemically analyzed for constituents and was found to have the following elements in decreasing order measured by percentage.

TABLE 8
Analysis of Mica #2

| Element | Percentage |
|---|---|
| Al | 7.94% |
| Fe | 5.49% |
| Mg | 1.52% |
| K | 1.42% |
| Ca | 1.17% |
| Na | 1.09% |
| Ti | 0.42% |
| S | 0.01% |

The mica #2 was chemically analyzed for additional constituents and was found to have the following elements in decreasing order measured in parts per million (ppm).

TABLE 9
Analysis of Mica #2

| Element | PPM |
|---|---|
| Mn | 1335 |
| P | 790 |
| Ba | 580 |
| Sr | 178 |
| V | 163 |
| Zn | 121 |
| Cr | 100 |
| Ni | 33 |
| Sc | 25 |
| Cu | 22 |
| Ga | 20 |
| La | 20 |
| Co | 12 |
| Pb | 11 |

Further experimentation is required to better understand the metes and bounds and full applications of this invention.

For example, experimentation can be conducted in which mica is used as a border substance with the uranium ore or other radioactive sample in the middle, to see if the mica has the same effective if it is used merely as a shield on the outside as opposed to being mixed together with the radioactive sample.

Another experiment could be to vary the sizes of the granules of the mica. Another experiment would be to vary the granule sizes of the uranium and or the radioactive sample.

Other experimental variations include varying the quantity of mica with respect to the uranium ore or other radioactive sample. It has been tested at a one-to-one ratio of mica to BL-5, however different ratios may also be effective and further experimentation may lead to a better understanding and/or optimization of the ratios that are effective.

Preferably all experiments would be completed contemporaneously with a uranium ore sample tested without a mica or other placebo added. Experimental runs can be completed with one or more placebo mica substitutes.

In addition, further experimentation may be performed using the existing samples to attempt to separate the BL-5 and/or the radioactive elements from the mica to see if it is separable, for example by centrifuge or other laboratory means. If separable the radioactivity of the mica and BL-5 can be further measured.

Further experimentation can test different types of mica and ascertain the effectiveness of various different forms of mica. The mica used in the experiments can be tested to assess whether there are other elements and/or components within the mica samples that may contribute to the effects observed.

The core invention is the reduction of radiation emitted from a radioactive sample by combining with mica, and these further experiments may further refine and improve the understanding of the invention without materially altering the invention.

It is intended that the present specification and examples be considered as exemplary only with a true scope and spirit of the invention being indicated by the following claims and equivalents thereof.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It will be appreciated by persons skilled in the art that the present invention is not limited by what has been particularly shown and described herein. Rather the scope of the present invention includes both combinations and sub-combinations of the features described herein as well as modifications and variations thereof which would occur to a person of skill in the art upon reading the foregoing description and which are not in the prior art. Furthermore, many alterations and modifications are possible in the practice of this invention without departing from the spirit or scope thereof. Accordingly, the scope of the invention is to be construed in accordance with the substance defined by the following claims.

What is claimed is:

1. A method of reducing radiation emitted from a radioactive source material comprising:
mixing mica with said radioactive source material.

2. The method of claim 1 wherein said radioactive source material is ground to small granules.

3. The method of claim 1 wherein said radioactive source material is ground to dust size particles.

4. The method of claim 1 wherein said radioactive source material is ground to 200 mesh.

5. The method of claim 4 further comprising the step of grinding the mica down to 200 mesh.

6. The method of claim 3 further comprising the step of grinding the mica down to dust size particles.

7. The method of claim 6 further comprising mixing said radioactive source material and said mica in a ratio of one to one.

8. The method of claim 5 further comprising mixing said radioactive source material and said mica in a ratio of one to one.

9. The method of claim 7 wherein said mica is a dark mica.

10. The method of claim 8 wherein said mica is a dark mica.

11. The method of claim 7 wherein said mica contains at least 800 ppm of manganese.

12. The method of claim 8 wherein said mica contains at least 800 ppm of manganese.

13. The method of claim 11 wherein said mica contains at least 3 percent of aluminum.

14. The method of claim 12 wherein said mica contains at least 3 percent of iron.

15. The method of claim 11 wherein said mica contains at least 700 ppm of phosphorus.

16. The method of claim 12 wherein said mica contains at least 1 percent potassium.

17. The method of claim 15 further comprising surrounding said radioactive source material with said mica.

18. The method of claim 16 further comprising surrounding said radioactive source material with said mica.

19. The method of claim 17 wherein said radioactive source material comprises uranium.

20. The method of claim 18 wherein said radioactive source material comprises uranium.
